(19) United States
(12) Patent Application Publication
(10) Pub. No.: US 2022/0256472 A1
(43) Pub. Date: Aug. 11, 2022

(54) PARAMETER ADJUSTMENTS OF COMPUTING DEVICES

(71) Applicant: Hewlett-Packard Development Company, L.P., Spring, TX (US)

(72) Inventors: Isaac Lagnado, Spring, TX (US); Steven Petit, Spring, TX (US); Alexander Wayne Clark, Spring, TX (US); Nick Thamma, Spring, TX (US); Shih Huang Wu, Spring, TX (US); Ruei-Ting Miau, Spring, TX (US)

(73) Assignee: Hewlett-Packard Development Company, L.P., Spring, TX (US)

(21) Appl. No.: 17/613,519

(22) PCT Filed: Sep. 12, 2019
(86) PCT No.: PCT/US2019/050818

§ 371 Date: Nov. 23, 2021

(51) Int. Cl. H04W 52/14; H04W 52/28

(52) U.S. Cl. CPC H04W 52/146; H04B 1/3838; H04W 52/288

(57) ABSTRACT

In an example implementation according to aspects of the present disclosure, a method may include monitoring a measurement from a sensor disposed within a computing device, filtering out noise from the measurement that is generated by a component of the computing device, determining a usage of the computing device, based on the post-filtered measurement, and adjusting a parameter of the computing device, based on the determined usage.

### BACKGROUND

Wireless computing devices may communicate with other wireless computing devices by exchanging radio frequency (RF) communication signals. As an example, such a wireless computing device may exchange (e.g., transmit and/or receive) RF communication signals by use of a wireless communications module of the wireless computing device. Transmitted power output of the wireless communications module may directly impact wireless performance, with higher transmitted power output limits allowing the wireless computing device to achieve greater throughput and/or broader wireless coverage (e.g., enhanced coverage areas).

### BRIEF DESCRIPTION OF THE DRAWINGS

FIG. 1 illustrates a computing device for determining a usage of the computing device and accordingly adjusting a parameter of the computing device, according to an example;

FIGS. 2A-D illustrate measurements monitored over a period of time via a sensor disposed within the computing device, according to an example;

FIGS. 3A-D illustrate additional measurements monitored over a period of time via the sensor, according to an example; and

FIG. 4 is a flow diagram in accordance with an example of the present disclosure.

### DETAILED DESCRIPTION

When a wireless computing device is used in relatively dose proximity to a user, the user can be exposed to some amount of electromagnetic (EM) radiation via wireless transmissions of the wireless computing device. To protect users from excessive exposure to EM radiation, government regulatory agencies have set radiation-related thresholds for wireless computing devices to comply with. The wireless transmissions of the wireless computing device are controlled such that exposure to EM radiation is mitigated and do not exceed the radiation-related thresholds. An example of a radiation-related threshold is a specific absorption rate (SAR), which refers to a measure of rate at which RF energy is absorbed by the human body when exposed to EM radiation. SAR can be expressed as power absorbed per mass of tissue (e.g., watts per gram). A government agency can specify a maximum SAR that wireless computing devices have to satisfy. Other types of radiation-related thresholds can include an effective radiated power (ERP) threshold, a maximum permissible exposure (MPE) time threshold, and so forth.

RF radiation exposure may be related to both transmitted power output of an antenna and separation distance (e.g., the distance separating an extremity of the human body and the RF radiation source), as well as other factors (e.g., shielding, antenna design, etc.). Specifically, the amount of RF radiation absorbed by a human body may increase when the transmitted power output increases, as well as when the separation distance decreases. As an example, a strategy for satisfying SAR compliance criteria may be to reduce the transmitted power output of the antenna to offset a reduction in separation distance (e.g., reducing the transmitted power output as the extremity of the human body approaches RF radiation source). Other strategies to offset a reduction in separation distance include, but are not limited to, switching to another antenna of the wireless device (e.g., away from the extremity), changing the data rate/modulation, and injecting idle times in the upload stream.

Examples disclosed herein provide the ability to adjust parameters of a computing device, based on a usage of the computing device. As will be further described, certain parameters may be adjusted based on how the computing device is being used, in order for the computing device to be operated in an efficient manner. With regards to controlling exposure to EM radiation, as described above, the parameters that may be adjusted based on usage may correspond to upload transmissions from a wireless communications module of the computing device. If a determination is made that the computing device is stationary, for example, by being utilized on a table, the upload transmissions may be adjusted, for example, by increasing the output power of the wireless communications module or increasing the duty cycle of upload transmissions, thereby allowing the computing device to achieve greater throughput and/or broader wireless coverage. However, if a determination is made that the computing device is likely in close proximity to a user, the upload transmissions may be adjusted, for example, by reducing the output power of the wireless communications module or reducing the duty cycle of upload transmissions. In addition to adjusting the adjusting the upload transmissions from the wireless communications module, other parameters that may be adjusted include, but are not limited to, the thermal exposure profile associated with the computing device, as will be further described.

As will be further described, the determination on how the computing device is being used may be made based on measurements from sensors disposed within the computing device. In order to make the determination more accurately, noise from the measurements that is generated by components of the computing device may be filtered out. As a result, if after the noise is filtered, the measurement is substantially constant, a determination may be made that the computing device is stationary, such as being used on a table, However, if the post-filtered measurement varies, a determination may be made that the computing device is mobile, for example, being held by a user or moved around. By adjusting parameters of the computing device based on usage, the computing device may be operated more efficiently.

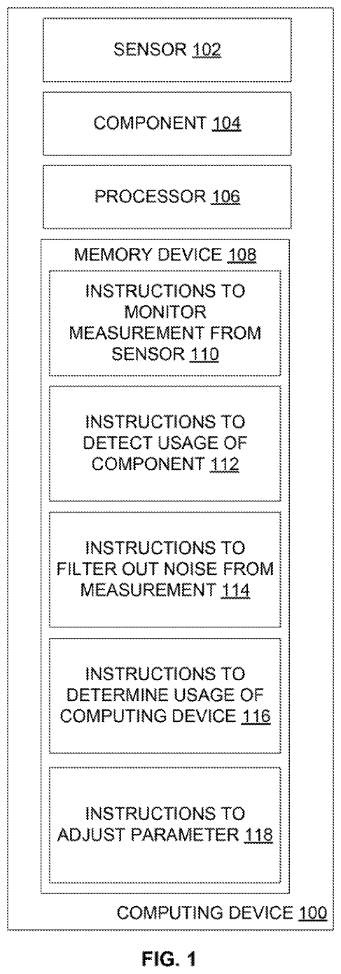

With reference to the figures, FIG. 1 illustrates a computing device 100 for determining a usage of the computing device 100 and accordingly adjusting a parameter of the computing device 100, according to an example. The computing device 100 depicts a processor 106 and a memory device 108 and, as an example of the computing device 100 performing its operations, the memory device 108 may include instructions 110-118 that are executable by the processor 108. Thus, memory device 108 can be said to store program instructions that, when executed by processor 106, implement the components of the computing device 100. The executable program instructions stored in the memory device 108 include, as an example, instructions to monitor measurement from sensor (110), instructions to detect usage of component (112), instructions to filter out noise from measurement (114), instructions to determine usage of computing device (116), and instructions to adjust parameter (118).

Instructions to monitor measurement from sensor (110) represent program instructions that when executed by the processor 106 cause the computing device 100 to monitor a measurement from a sensor 102 that may be disposed within the computing device 100. As an example, the measurement may account for any movement or vibrations associated with the computing device 100. For example, sensor 102 may measure vibrations generated while the computing device 100 is being utilized, in addition, sensor 102 may detect and measure movement of the computing device 100, for example, while it is being utilized in the hands of a user or while the user is traveling via a mode of transportation, such as train, bus, or car. Examples of sensors that may perform such measurements, particularly dealing with movement and/or vibrations, include, but are not limited to, accelerometers, magnetometers, and gyroscopes, which may be used alone or in various combinations.

Instructions to detect usage of component (112) represent program instructions that when executed by the processor 106 cause the computing device 100 to detect usage of a component 104 of the computing device 100, Examples of the component 104 include, but are not limited to a keyboard, trackpad, or touch panel of the computing device 100, such as a display member of a notebook computer. As an example, usage of the component 104 may be detected when input from the component 104 is received, for example, if input is received from the keyboard, trackpad, or touch panel. The component 104 may refer to other embedded devices of the computing device 100 whose impact to the measurement made above is known and quantifiable, as will be further described. Examples of other embedded devices include, but are not limited to, fans or speakers of the computing device 100 where, although their purpose may not be for user input, may impact the measurement made by sensor 102.

Instructions to filter out noise from measurement (114) represent program instructions that when executed by the processor 106 cause the computing device 100 to filter out noise from the measurement that is associated with such usage of the component 104. As mentioned above, vibration associated with the component 104, when it is detected, may be known and quantifiable. For example, if the component 104 is a keyboard, the vibration generated when keys are struck may be known and quantifiable. Similarly, if the component 104 is a trackpad or touch panel, the vibration generated when usage of either component is detected may be unique to the particular component. As a result, while the sensor 102 measures movement or vibrations associated with the computing device 100, at least a portion of the measurement may be due to vibrations generated while component 104 of the computing device 100 is utilized to operate the computing device 100. As a result, such vibrations or noise generated during utilization of component 104 may be filtered out from the measurement described above. What remains, after noise from the measurement that is generated by the component 104 is removed, is a filtered out measurement, or post-filtered measurement.

As an example, in addition to removing any noise from the measurement that is generated when component 104 is utilized, additional noise may be removed from the measurement before a determination is made how the computing device 100 is being used (e.g., stationary or mobile), as will be described below. For example, as the sensor 102 accounts for vibrations generated as the computing device 100 is being utilized while the user is traveling via a mode of transportation (e.g., train, bus, or car), another sensor disposed within the computing device 100, such as a GPS sensor, may in fact be utilized to confirm whether the computing device 100 is being utilized while it is being moved around fast, which may only be possible via a mode of transportation, such as train, bus, or car. If it is confirmed that the computing device 100 is being utilized in such a manner, a known and quantifiable measurement associated with such modes of transportation may be removed from measurement collected by sensor 102.

Instructions to determine usage of computing device (116) represent program instructions that when executed by the processor 106 cause the computing device 100 to determine a usage of the computing device 100, based on the post-filtered measurement. As an example, if the post-filtered measurement is a constant value, or a substantially constant value, it may be determined that the computing device 100 is likely stationary, for example, being utilized on a surface, such as a table. As described above, if It is determined that the computing device 100 is being utilized while the user is traveling via a mode of transportation, any noise generated by such mode of transportation may be filtered out from the measurement as well. As a result, a determination may be made that the computing device 100 is stationary, evening if the computing device 100 is being utilized on a seat tray while traveling on a train. As an example, after filtering out the noise, if the post-filtered measurement has a varying value, it may be determined that the computing device 100 is mobile, for example, being held by a user (e.g., in a hand of the user).

Instructions to adjust parameter (118) represent program instructions that when executed by the processor 106 cause the computing device 100 to adjust a parameter of the computing device 100, based on the determined usage. As an example, the parameter that may be adjusted may correspond to upload transmissions from a wireless communications module of the computing device 100, or a thermal exposure profile associated with the computing device 100. With regards to upload transmissions, if a determination is made that the computing device 100 is stationary, for example, by being utilized on a table, the upload transmissions may be adjusted, for example, by increasing the output power of the wireless communications module or increasing the duty cycle of upload transmissions, thereby allowing the computing device 100 to achieve greater throughput and/or broader wireless coverage. However, if a determination is made that the computing device 100 is mobile, thereby likely in close proximity to the user of the computing device 100, the upload transmissions may be adjusted, for example, by reducing the output power of the wireless communications module or reducing the duty cycle of upload transmissions, thereby controlling any excessive exposure to EM radiation.

With regards to the thermal exposure profile associated with the computing device 100, if a determination is made that the computing device 100 is stationary, for example, by being utilized on a table, the thermal exposure profile for operating the computing device 100 may be increased, allowing for greater processing power of the computing device 100 to be utilized, which may in turn increase the skin temperature of the computing device 100, which may not be an issue as the computing device 100 is stationary. However, if a determination is made that the computing device 100 is mobile, thereby likely in close proximity to the user of the computing device 100 or being held by the user, the thermal exposure profile for operating the computing device 100 may be decreased, potentially reducing the processing power of the computing device 100, so that the skin temperature may not be uncomfortable while being held by the user. As a result, the processing power may be adjusted to provide a more satisfactory user experience, based on whether the computing device 100 is stationary or mobile.

Memory device 104 represents generally any number of memory components capable of storing instructions that can be executed by processor 102. Memory device 104 is non-transitory in the sense that it does not encompass a transitory signal but instead is made up of at least one memory component configured to store the relevant instructions. As a result, the memory device 104 may be a non-transitory computer-readable storage medium. Memory device 104 may be implemented in a single device or distributed across devices. Likewise, processor 102 represents any number of processors capable of executing instructions stored by memory device 104. Processor 102 may be integrated in a single device or distributed across, devices. Further, memory device 104 may be fully or partially integrated in the same device as processor 102, or it may be separate but accessible to that device and processor 102.

In one example, the program instructions 110-118 can be part of an installation package that when installed can be executed by processor 106 to implement the components of the computing device 100. In this case, memory device 106 may be a portable medium such as a CD, DVD, or flash drive or a memory maintained: by a server from which the installation package can be downloaded and installed. In another example, the program instructions may be part of an application or applications already installed. Here, memory device 106 can include integrated memory such as a hard drive, solid state drive, or the like.

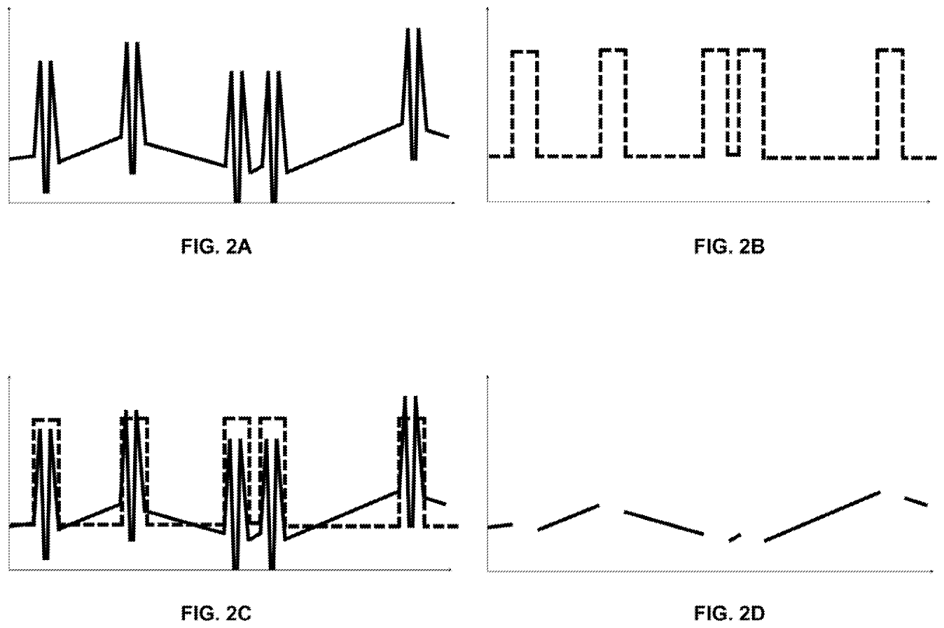

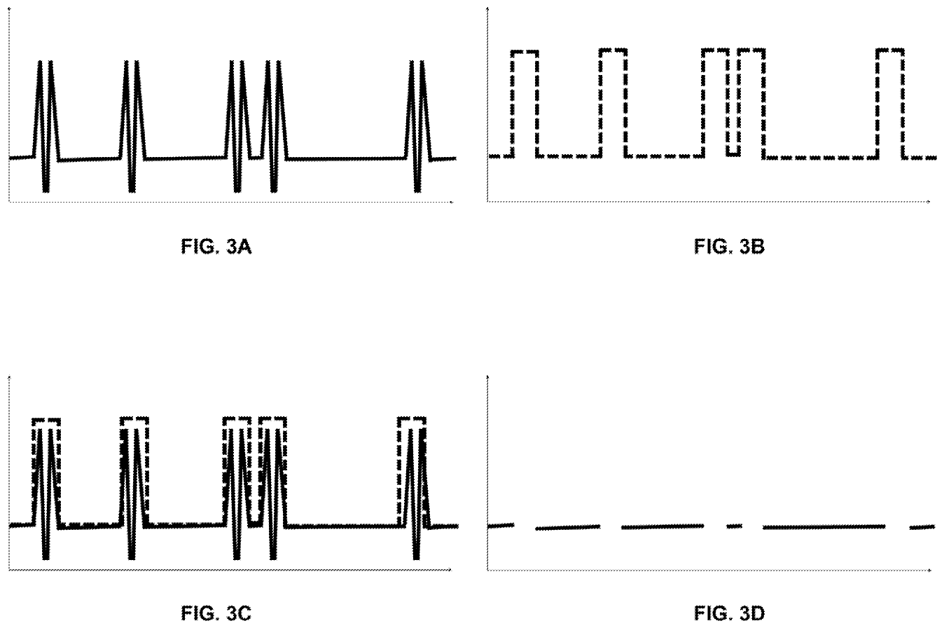

FIGS. 2 and 3 illustrate measurements monitored over a period of time, for example, via sensor 102 disposed within computing device 100, according to an example. Reference may be made back to computing device 100 of FIG. 1 when describing the charts illustrated in FIGS. 2 and 3. As will be further described, FIGS. 2A-D illustrate post-filtered measurements that indicate the computing device is likely mobile. In addition, FIGS. 3A-D illustrate post-filtered measurements that indicate the computing device is likely stationary, as will be further described.

Referring to FIG. 2A, sensor 102 disposed within computing device 100 may monitor a measurement 202 over a period of time. As an example, the measurement 202 may account for any movement or vibrations associated with the computing device 100, as described above. Referring to FIG. 2B, the computing device 100 may detect usage of component 104 of the computing device 100 (illustrated by 204). As described above, examples of the component 104 include, but are not limited to a keyboard, trackpad, or touch panel of the computing device 100, such as a display member of a notebook computer, in addition to other embedded devices. As an example, usage of the component 104 may be detected when input from the component 104 is received, for example, if input is received from the keyboard, trackpad, or touch panel, Referring to FIG. 2B, such usage of the component 104 may be indicated by the peaks illustrated on the chart. Referring to FIG. 2C, by lining up measurement 202 from FIG. 2A with detected usage 204 from FIG. 2B, it becomes clearer when certain vibrations indicated by measurement 202 may be due to detected usages of component 104. As a result, referring to FIG. 2D, upon filtering out noise from the measurement 202 that is likely generated by component 104, a post-filtered measurement 206 remains. As illustrated, the post-filtered measurement 206 is varying. As a result, a determination may be made that the computing device 100 is mobile, for example, being held by a user (e.g., in a hand of the user). Upon making this determination, a parameter of the computing device 100 may be adjusted, based on the determined usage (e.g., adjusting upload transmissions or thermal exposure profile). With regards to upload transmissions, the upload transmissions may be adjusted, for example, by reducing the output power of the wireless communications module or reducing the duty cycle of upload transmissions, thereby controlling any excessive exposure to EM radiation. With regards to the thermal exposure profile, the thermal exposure profile for operating the computing device 100 may be decreased, potentially reducing the processing power of the computing device 100, so that the skin temperature may not be uncomfortable while being held by the user.

Referring to FIG. 3A, sensor 102 disposed within computing device 100 may monitor a measurement 302 over a period of time. As an example, the measurement 302 may account for any movement or vibrations associated with the computing device 100, as described above. Referring to FIG. 3B, the computing device 100 may detect usage of component 104 of the computing device 100 (illustrated by 304). As an example, usage of the component 104 may be detected when input from the component 104 is received, for example, if input is received from a keyboard, trackpad, or touch panel. Referring to FIG. 3B, such usage of the component 104 may be indicated by the peaks illustrated on the chart. Referring to FIG. 3C, by lining up measurement 302 from FIG. 3A with detected usage 304 from FIG. 3B, it becomes clearer when certain vibrations indicated by measurement 302 may be due to detected usages of component 104. As a result, referring to FIG. 3D, upon filtering out noise from the measurement 302 that is likely generated by component 104, a post-filtered measurement 306 remains. As illustrated, the post-filtered measurement 206 is substantially constant. As a result, a determination may be made that the computing device 100 is stationary, for example, by being utilized on a table. Upon making this determination, a parameter of the computing device 100 may be adjusted, based on the determined usage (e.g., adjusting upload transmissions or thermal exposure profile), With regards to upload transmissions, the upload transmissions may be adjusted, for example, by increasing the output power of the wireless communications module or increasing the duty cycle of upload transmissions, thereby allowing the computing device 100 to achieve greater throughput and/or broader wireless coverage. With regards to the thermal exposure profile, the thermal exposure profile for operating the computing device 100 may be increased, allowing for greater processing power of the computing device 100 to be utilized, which may in turn increase the skin temperature of the computing device 100, which may not be an issue as the computing device 100 is stationary.

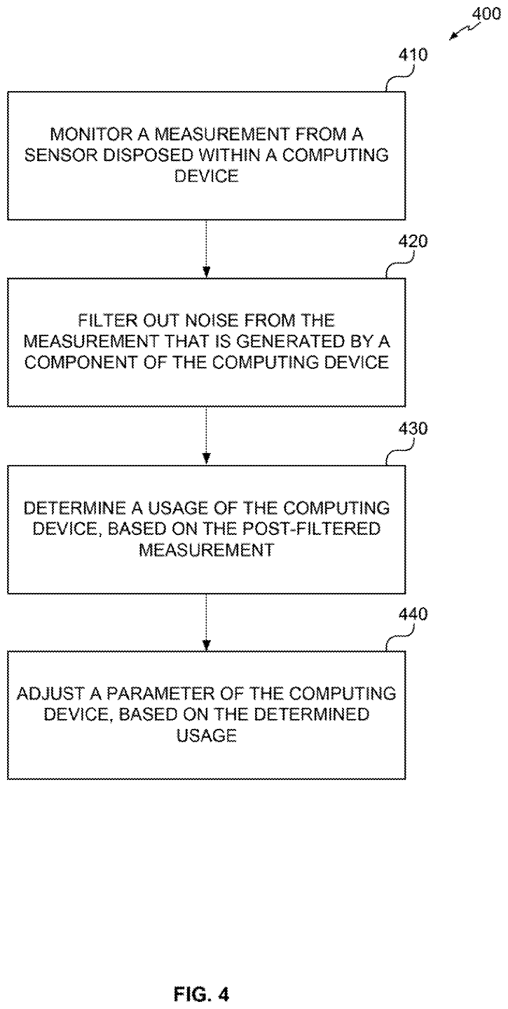

FIG. 4 is a flow diagram 400 of steps taken by a computing device when determining a usage of the computing device and accordingly adjusting a parameter of the computing device, according to an example. Although the flow diagram of FIG. 4 shows a specific order of execution, the order of execution may differ from that which is depicted. For example, the order of execution of two or more blocks or arrows may be scrambled relative to the order shown. Also, two or more blocks shown in succession may be executed concurrently or with partial concurrence. All such variations are within the scope of the present disclosure.

At 410, the computing device monitors a measurement from a sensor disposed within the computing device. As an example, the measurement accounts for movement or vibrations associated with the computing device.

At 420, the computing device filters out noise from the measurement that is generated by a component of the computing device. As an example, the component may refer to a keyboard, a trackpad, a touch panel, or other embedded devices of the computing device whose impact to the measurement is known and quantifiable. As an example of filtering out the noise, the computing device detects usage of the component of the computing device, and filters out the noise from the measurement that is associated with such usage.

At 430, the computing device determines a usage of the computing device, based on the post-filtered measurement. As an example, if the post-filtered measurement is constant, or substantially constant, the computing device determines that the computing device is likely stationary. However, if the post-filtered measurement varies, or varies over a certain threshold. the computing device determines that the computing device is likely mobile, for example, held by a user.

440, the computing device adjusts a parameter of the computing device, based on the determined usage. As an example, the parameter may refer to upload transmissions from a wireless communications module of the computing device, or a thermal exposure profile associated with the computing device.

It is appreciated that examples described may include various components and features. It is also appreciated that numerous specific details are set forth to provide a thorough understanding of the examples. However, it is appreciated that the examples may be practiced without limitations to these specific details. In other instances, well known methods and structures may not be described in detail to avoid unnecessarily obscuring the description of the examples. Also, the examples may be used in combination with each other.

Reference in the specification to “an example” or similar language means that a particular feature, structure, or characteristic described in connection with the example is included in at least one example, but not necessarily in other examples.

The various instances of the phrase “in one example” or similar phrases in various places in the specification are not necessarily all referring to the same example.

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the scope of the disclosure. Thus, the present disclosure is not intended to be limited to the examples shown herein but is to be accorded the widest scope consistent with the principles and novel features disclosed herein.

What is claimed is:

1. A method comprising:
monitoring a measurement from a sensor disposed within a computing device;
filtering out noise from the measurement that is generated by a component of the computing device;
determining a usage of the computing device, based on the post-filtered measurement; and
adjusting a parameter of the computing device, based on the determined usage.

2. The method of claim 1, wherein the measurement accounts for movement or vibrations associated with the computing device.

3. The method of claim 1, wherein filtering out the noise comprises:
detecting usage of the component of the computing device; and
filtering out the noise from the measurement that is associated with such usage.

4. The method of claim 1, wherein determining the usage comprises:
determining the computing device is stationary if the post-filtered measurement is constant.

5. The method of claim 1, wherein determining the usage comprises:
determining the computing device is mobile if the post-filtered measurement is varying.

6. The method of claim 1, wherein the parameter comprises upload transmissions from a wireless communications module of the computing device, and a thermal exposure profile associated with the computing device.

7. The method of claim 1, wherein the component comprises a keyboard, a trackpad, a touch panel, and other embedded devices whose impact to the measurement is known and quantifiable.

8. A non-transitory computer-readable storage medium comprising program instructions which, when executed by a processor of a computing device, cause the processor to:
monitor a measurement from a sensor disposed within the computing device;
detect usage of a component of the computing device;
filter out noise from the measurement that is associated with such usage of the component;
determine a usage of the computing device, based on the post-filtered measurement; and
adjust a parameter of the computing device, based on the determined usage.

9. The non-transitory computer-readable storage medium of claim 8, wherein the measurement accounts for movement or vibrations associated with the computing device.

10. The non-transitory computer-readable storage medium of claim 8, wherein the instructions to determine the usage comprises instructions which, when executed by the processor, cause the processor to determine the computing device is stationary if the post-filtered measurement is constant.

11. The non-transitory computer-readable storage medium of claim 8, wherein the instructions to determine the usage comprises instructions which, when executed by the processor, cause the processor to determine the computing device is mobile if the post-filtered measurement is varying.

12. The non-transitory computer-readable storage medium of claim 8, wherein the parameter comprises upload transmissions from a wireless communications module of the computing device, and a thermal exposure profile associated with the computing device.

13. A computing device comprising:
a sensor;
a component; and
a processor to;
monitor a measurement from the sensor;
filter out noise from the measurement that is generated by the component;
determine a usage of the computing device, based on the post-filtered measurement; and
adjust a thermal exposure profile associated with the computing device, based on the determined usage.

14. The computing device of claim 13, wherein the processor to determine the usage comprises determining the computing device is stationary if the post-filtered measurement is constant.

15. The computing device of claim 13, wherein the processor to determine the usage comprises determining the computing device is mobile if the post-filtered measurement is varying.
